(19) United States
(12) Patent Application Publication
(10) Pub. No.: US 2020/0077196 A1
(43) Pub. Date: Mar. 5, 2020

(54) DIAPHRAGM OR DUST CAP AND SPEAKER UNIT

(71) Applicant: Onkyo Corporation, Osaka (JP)

(72) Inventor: Takeru INOUE, Osaka (JP)

(21) Appl. No.: 16/531,093

(22) Filed: Aug. 4, 2019

(30) Foreign Application Priority Data
Aug. 29, 2018 (JP) 2018- 160625

(51) Int. Cl. H04R 7/12; H01F 7/08; H01F 7/126; H04R 7/18; H04R 9/06; H04R 9/02

(52) U.S. Cl. CPC H04R 7/127; H01F 7/081; H01F 7/126; H04R 2400/11; H04R 9/06; H04R 9/025; H04R 7/18

(57) ABSTRACT

There is provided a diaphragm or a dust cap configured to emit a sound wave and an electrodynamic speaker unit including the diaphragm or the dust cap. In the diaphragm or the dust cap, multiple contours defining the shape of a curved surface of a diaphragm portion configured to emit a sound wave are each defined by multiple regular polygons configured such that all corner portions thereof are chamfered in arcs, the regular polygons are arranged with different predetermined rotation angles about the center point of a concentric circle such that the position of the corner portion of the regular polygon in a circumferential direction is different between adjacent ones of the contours, and spiral recessed-raised portions corresponding to the multiple contours are formed at the curved surface.

### BACKGROUND OF THE INVENTION

### 1. Field of the Invention

The present invention relates to a diaphragm or a dust cap configured to emit a sound wave and an electrodynamic speaker unit including the diaphragm or the dust cap.

### 2. Description of the Related Art

In an electrodynamic speaker unit, an assembly structure in which an inner peripheral end of a speaker diaphragm (specifically, a cone diaphragm) is, with an adhesive, bonded to a cylinder side surface of a cylindrical voice coil bobbin is often used. In an electrodynamic speaker, audio signal current is supplied to a coil wound around the voice coil bobbin.

An edge is coupled to an outer diameter portion of the cone diaphragm, an outer peripheral end side of the edge is fixed to a frame coupled to a magnetic circuit, and a coil of a voice coil is arranged in a magnetic gap of the magnetic circuit. A dust cap is attached to prevent a foreign substance from entering the voice coil bobbin and the magnetic gap of the magnetic circuit. As a result, when the diaphragm and the voice coil vibrate, the diaphragm and the dust cap emit sound waves.

The shapes of the diaphragm and the dust cap influence quality and sound pressure frequency characteristics of audio reproduced by the electrodynamic speaker unit. The diaphragm and the dust cap need both of lightness and structure strength. For some of typical speakers, the shape of a cone diaphragm or a dust cap is designed to improve acoustic characteristics including smoothing of sound pressure frequency characteristics. In a circular cone diaphragm, a vibration system configuration has favorable symmetry with respect to a center axis. As a result, there is an advantage that operation failure such as rolling less occurs. On the other hand, when stiffness of the cone diaphragm is lowered, there is a problem that due to a circular shape, influence of a divided vibration mode becomes notable, and a peak dip of sound pressure frequency characteristics becomes greater. This may lead to lowering of reproduced sound quality.

For example, JP-UM-A-2-43093 as a typical technique discloses a speaker diaphragm configured such that a contour shaping a conical diaphragm having a circular inner peripheral portion and a circular outer peripheral portion is a polygon (a square) (FIGS. 3 and 4). Significant division resonance due to non-uniform stiffness of a diaphragm portion in a circumferential direction is not caused, and frequency characteristics are smoothed.

Moreover, Japanese Patent No. 3796937 as a typical technique discloses a speaker using a diaphragm. The diaphragm is configured such that a voice coil is joined to at least an inner periphery and the contour and outer periphery of a curved surface from an outer periphery to the inner periphery are polygons. The diaphragm is formed to gradually change to a circular shape toward the periphery of a center portion as a portion joined to the voice coil. Further, a polygonal roll edge having the same inner periphery as the outer periphery of the diaphragm is bonded to the outer periphery of the diaphragm.

Further, Japanese Patent No. 3508834 as a typical technique discloses a speaker using a speaker diaphragm. The speaker diaphragm includes multiple raised portions radially provided from a center portion to an edge portion at an inclined portion of the substantially-conical speaker diaphragm, curved in a circumferential direction toward the edge portion, and forming a periodic structure along the circumferential direction, and multiple recessed portions each formed between adjacent ones of the multiple raised portions. The speaker diaphragm is configured such that at least one of surfaces from the multiple raised portion toward the multiple recessed portions is formed curved.

The present invention has been made for solving the above-described problems of the typical techniques, and an object of the present invention is to provide a diaphragm or a dust cap configured to emit a sound wave and an electrodynamic speaker unit including the diaphragm or the dust cap. The speaker unit is configured so that a great peak dip of sound pressure frequency characteristics due to influence of a divided vibration mode can be prevented and excellent reproduced sound quality can be provided.

### SUMMARY OF THE INVENTION

The diaphragm or the dust cap of the present invention is a diaphragm or a dust cap forming an electrodynamic speaker unit. Multiple contours defining the shape of a curved surface of a diaphragm portion configured to emit a sound wave are each defined by multiple regular polygons configured such that all corner portions thereof are chamfered in arcs, the regular polygons are arranged with different predetermined rotation angles about the center point of a concentric circle such that the position of the corner portion of the regular polygon in a circumferential direction is different between adjacent ones of the contours, and spiral recessed-raised portions corresponding to the multiple contours are formed at the curved surface.

Preferably, in the diaphragm or the dust cap of the present invention, the radiuses r of the arcs in which the corner portions of each regular polygon are chamfered are set to be different among all corner portions of one of the contours.

Preferably, in the diaphragm or the dust cap of the present invention, the maximum value rₘₐₓ of the radius r of one of the arcs at one of the contours is set equal to or greater than one time as great as the minimum value rₘᵢₙ of the radius r of another one of the arcs and equal to or less than four times as great as the minimum value rₘᵢₙ of the radius r of the another one of the arcs.

Preferably, in the diaphragm or the dust cap of the present invention, each regular polygon is preferably a regular triangle, a square, a regular pentagon, a regular hexagon, a regular heptagon, or a regular octagon.

Preferably, in the diaphragm or the dust cap of the present invention, in a case where each regular polygon is the square, the regular pentagon, the regular hexagon, the regular heptagon, or the regular octagon, the radiuses r of the arcs in which the corner portions of each regular polygon are chamfered are differently set without monotonically increasing or decreasing in a path of a single lap around one of the contours.

Preferably, the diaphragm of the present invention further includes an inner diameter portion defining a circular hole, an outer diameter portion defining a circular edge portion as a circle concentric with the inner diameter portion, and the diaphragm portion having the substantially conical curved surface connecting the inner diameter portion and the outer diameter portion. The radiuses r of the arcs in which the corner portions of each regular polygon are chamfered are set greater in the case of the contour closer to the outer diameter portion than in the case of the contour closer to the inner diameter portion.

Moreover, a speaker unit of the present invention at least includes the above-described diaphragm, a voice coil coupled to the inner diameter portion of the diaphragm, an edge coupled to the outer diameter portion of the diaphragm, a frame fixed to an outer peripheral end portion of the edge, and a magnetic circuit having a magnetic gap in which a coil of the voice coil is arranged and fixed to the frame.

Further, a speaker unit of the present invention at least includes a conical diaphragm, a voice coil coupled to an inner diameter portion of the diaphragm, the above-described dust cap coupled to the diaphragm or the voice coil, an edge coupled to an outer diameter portion of the diaphragm, a frame fixed to an outer peripheral end portion of the edge, and a magnetic circuit having a magnetic gap in which a coil of the voice coil is arranged and fixed to the frame.

Hereinafter, features of the present invention will be described.

The diaphragm or the dust cap of the present invention is the diaphragm or the dust cap forming the electrodynamic speaker unit, the shape of the curved surface of the diaphragm portion configured to emit the sound wave being defined by the multiple contours. The speaker unit of the present invention includes the diaphragm or the dust cap, the frame fixed to the outer peripheral end portion of the edge portion of the diaphragm, a terminal fixed to the frame and connected to the coil of the voice coil, and the magnetic circuit having the magnetic gap in which the coil of the voice coil is arranged and fixed to the frame.

The multiple contours defining the shape of the curved surface of the diaphragm portion of the diaphragm or the dust cap are each defined by the multiple regular polygons configured such that all corner portions thereof are chamfered in the arcs.

Moreover, the regular polygons of the multiple contours are arranged with the different predetermined rotation angles about the center point of the concentric circle such that the position of the corner portion of the regular polygon in the circumferential direction is different between adjacent ones of the contours. As a result, at the diaphragm or the dust cap, the spiral raised-recessed portions corresponding to the curved surface formed by a row of the corner portions of the regular polygons of the multiple contours are formed at the curved surface of the diaphragm portion. The spiral raised-recessed portions of the curved surface enhance stiffness of the diaphragm portion of the diaphragm or the dust cap. Thus, the speaker unit configured so that a peak dip of sound pressure frequency characteristics easily emerged due to influence of a divided vibration mode can be reduced and excellent reproduced sound quality can be provided.

For the multiple contours defining the shape of the curved surface of the diaphragm portion, the radiuses r of the arcs in which the corner portions of the regular polygon are chamfered are preferably set to be different among all corner portions of one contour. Moreover, the maximum value rₘₐₓ of the radius r of the arc at one contour is preferably set equal to or greater than one time as great as the minimum value rₘᵢₙ of the radius r of another arc and equal to or less than four times as great as the minimum value rₘᵢₙ of the radius r of the another arc. Further, in a case where the diaphragm is a cone diaphragm having an inner diameter portion defining a circular hole, an outer diameter portion defining a circular edge portion as a circle concentric with the inner diameter portion, and a diaphragm portion having a substantially conical curved surface connecting the inner diameter portion and the outer diameter portion, the radius r of the arc in which the corner portion of the regular polygon is chamfered is preferably set greater in the case of the contour closer to the outer diameter portion than in the case of the contour closer to the inner diameter portion. With different arc radiuses r, the spiral recessed-raised shapes of the curved surface are different from each other. Thus, divided vibration at a particular frequency can be reduced, the sound pressure frequency characteristics of the speaker unit can be more smoothed, and excellent reproduced sound quality can be provided.

For the multiple contours defining the shape of the curved surface of the diaphragm portion, the regular polygon is preferably the regular triangle, the square, the regular pentagon, the regular hexagon, the regular heptagon, or the regular octagon. In a case where the regular polygon is the square, the regular pentagon, the regular hexagon, the regular heptagon, or the regular octagon, the radiuses r of the arcs in which the corner portions of the regular polygon are chamfered are differently set without monotonically increasing or decreasing in the path of the single lap around one contour. With this configuration, divided vibration can be more effectively reduced.

The diaphragm or the dust cap and the electrodynamic speaker unit including the diaphragm or the dust cap according to the present invention can provide a speaker unit configured so that a great peak dip of sound pressure frequency characteristics due to influence of a divided vibration mode can be prevented and excellent reproduced sound quality can be provided.

### BRIEF DESCRIPTION OF THE DRAWINGS

FIG. 1 is an external view of an electrodynamic speaker unit according to one embodiment of the present invention;

FIGS. 2A and 2B are external views of models for describing the shape of a diaphragm according to one embodiment of the present invention and the shape of a diaphragm of a comparative example;

FIGS. 3A, 3B, 3C, and 3D are views of the shape of a diaphragm according to one embodiment of the present invention and a graph of sound pressure frequency characteristics of an electrodynamic speaker unit using the diaphragm;

FIGS. 4A, 4B, 4C, and 4D are views of the shape of a diaphragm according to one embodiment of the present invention and a graph of sound pressure frequency characteristics of an electrodynamic speaker unit using the diaphragm;

FIGS. 5A, 5B, 5C, and 5D are views of the shape of a diaphragm according to one embodiment of the present invention and a graph of sound pressure frequency characteristics of an electrodynamic speaker unit using the diaphragm;

FIGS. 6A, 6B, 6C, and 6D are views of the shape of a diaphragm of a comparative example and a graph of sound pressure frequency characteristics of an electrodynamic speaker unit using the diaphragm;

FIGS. 7A, 7B, 7C, and 7D are views of the shape of a diaphragm of a comparative example and a graph of sound pressure frequency characteristics of an electrodynamic speaker unit using the diaphragm;

FIGS. 8A, 8B, and 8C are views of the shape of a diaphragm according to one embodiment of the present invention; and

FIGS. 9A, 9B, and 9C are views of the shape of a dust cap according to one embodiment of the present invention.

### DETAILED DESCRIPTION OF THE PREFERRED EMBODIMENTS

Hereinafter, a diaphragm or a dust cap and a speaker unit according to preferred embodiments of the present invention will be described, but the present invention is not limited to these embodiments.

### First Embodiment

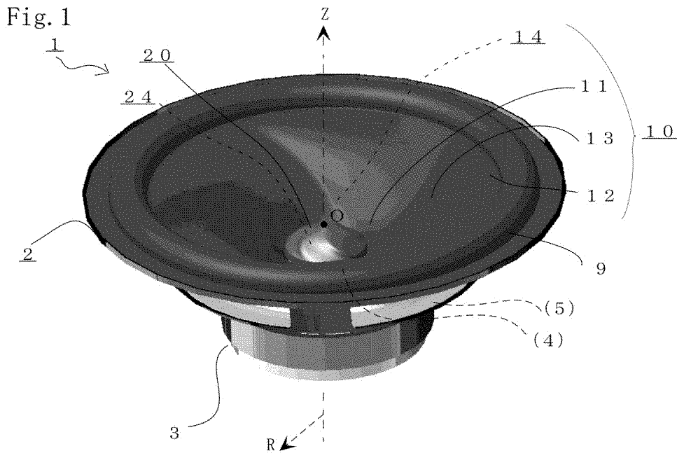

FIG. 1 is a view for describing an electrodynamic speaker unit 1 according to a preferred embodiment of the present invention. Specifically, FIG. 1 is a perspective view of an outer appearance of the speaker unit 1 including a cone diaphragm and a dust cap from a front side. Note that the form of the speaker unit 1 is not limited to the case of the present embodiment. Moreover, configurations of the speaker unit 1 unnecessary for description of the present invention are not shown in the figures, and are not described.

The speaker unit 1 of the present embodiment is an electrodynamic speaker for a speaker system or vehicle attachment, the electrodynamic speaker having a nominal diameter of 16 cm. The speaker unit 1 is attached to, e.g., a cabinet forming the speaker system or a body/door of a vehicle to form a speaker configured to reproduce audio. Note that, e.g., a specific form of the speaker system using the speaker unit 1 is not shown in the figures, and is not described.

The speaker unit 1 includes a basket-shaped frame 2 made of a metal material, a magnetic circuit 3 fixed to the frame 2, a conical diaphragm 10 formed by papermaking of a paper material, a (not-shown) voice coil 4 coupled to an inner peripheral side of the diaphragm 10 and having a coil arranged in a (not-shown) magnetic gap of the (not-shown) magnetic circuit 3, a (not-shown) damper 5 coupled to and vibratably supporting a (not-shown) bobbin of the voice coil 4, an edge 9 coupled to an outer peripheral side of the diaphragm 10 and vibratably supporting the diaphragm 10, and a dust cap 20 attached to close an upper end side of the (not-shown) bobbin of the voice coil 4. Note that the voice coil 4 and the damper 5 are positioned and hidden on a back side of the diaphragm 10 in FIG. 1, and therefore, outer appearances thereof are not shown.

Thus, in the speaker unit 1, when audio signal current is supplied to the coil of the voice coil 4 arranged in the magnetic gap of the magnetic circuit 3 generating a strong DC field, drive force is generated in an illustrated Z-axis direction, and a speaker vibration system including the voice coil 4, the diaphragm 10, and the dust cap 20 is driven in the Z-axis direction. That is, the speaker vibration system is vibratably supported by the damper 5 and the edge 9. As a result, a pressure change occurs in air present in the front and back of the diaphragm 10 and the dust cap 20, and the audio signal current is converted into a sound wave (audio).

The conical diaphragm 10 has an inner diameter portion 11 defining a circular hole, an outer diameter portion 12 defining a circular edge portion as a circle concentric with the inner diameter portion 11, and a diaphragm portion 13 having a substantially conical curved surface connecting the inner diameter portion 11 and the outer diameter portion 12. Further, at the diaphragm 10, multiple spiral recessed-raised portions 14 are formed at the curved surface of the diaphragm portion 13. Moreover, the dust cap 20 has an outer diameter portion 22 defining a circular edge portion, and a substantially dome-shaped diaphragm portion 23. Multiple spiral recessed-raised portions 24 are formed at a curved surface of the diaphragm portion 23.

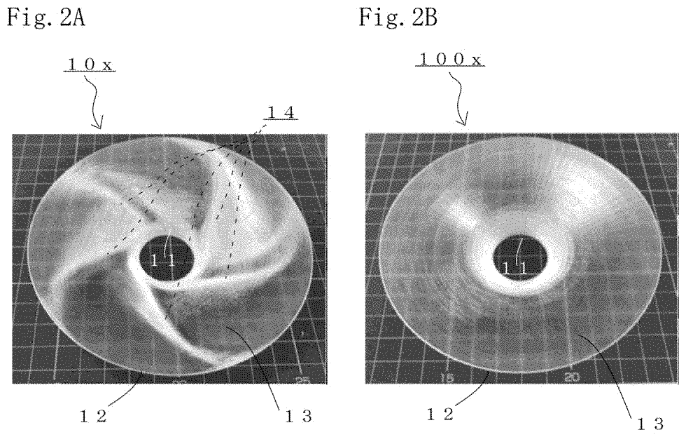

FIGS. 2A and 2B are external views of models for describing the shape of a diaphragm 10x of the present embodiment and the shape of a diaphragm 100x of a comparative example. Specifically, FIG. 2A is a photograph of the model diaphragm 10x made of transparent resin for describing the shape of the diaphragm 10 of the present embodiment, and FIG. 2B is a photograph of the model diaphragm 100x made of transparent resin for describing the shape of the diaphragm 100 of the comparative example. The diaphragm 100 of the comparative example has no recessed-raised portions on a curved surface of a diaphragm portion 13, and therefore, the diaphragm portion 13 of the model diaphragm 100x defines a transparent smooth substantially-conical curved surface. On the other hand, in the diaphragm 10 of the present embodiment, five spiral recessed-raised portions 14 are formed at a curved surface of a diaphragm portion 13, and therefore, the diaphragm portion 13 of the model diaphragm 10x seems cloudy.

The diaphragm portion 13 of the diaphragm 10 of the present embodiment is configured such that the shape of a curved surface thereof is defined by multiple contours. These contours are defined by multiple regular pentagons configured such that all corner portions thereof are chamfered in an arc. For the multiple contours, the regular pentagons are arranged with different predetermined rotation angles about the center point O of a concentric circle such that the position of the corner portion of the regular pentagon in a circumferential direction is different between adjacent ones of the contours. As a result, spiral recessed-raised portions 14 formed by connection of the corner portions of the regular pentagons of the multiple contours are formed at the diaphragm portion 13 of the diaphragm 10 as illustrated in FIG. 2A.

The spiral recessed-raised portions 14 of the diaphragm portion 13 enhance stiffness of the diaphragm portion 13 of the diaphragm 10. Thus, a speaker unit 1 using the diaphragm 10 reduces a peak dip of sound pressure frequency characteristics easily emerged due to influence of a divided vibration mode, and provides excellent reproduced sound quality. On the other hand, in the diaphragm 100 of the comparative example, the influence of the divided vibration mode is easily emerged as the peak dip of the sound pressure frequency characteristics.

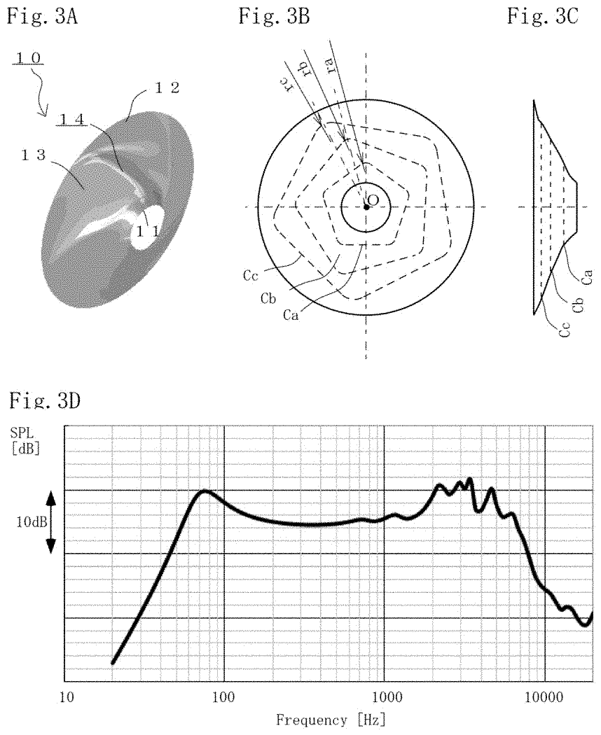

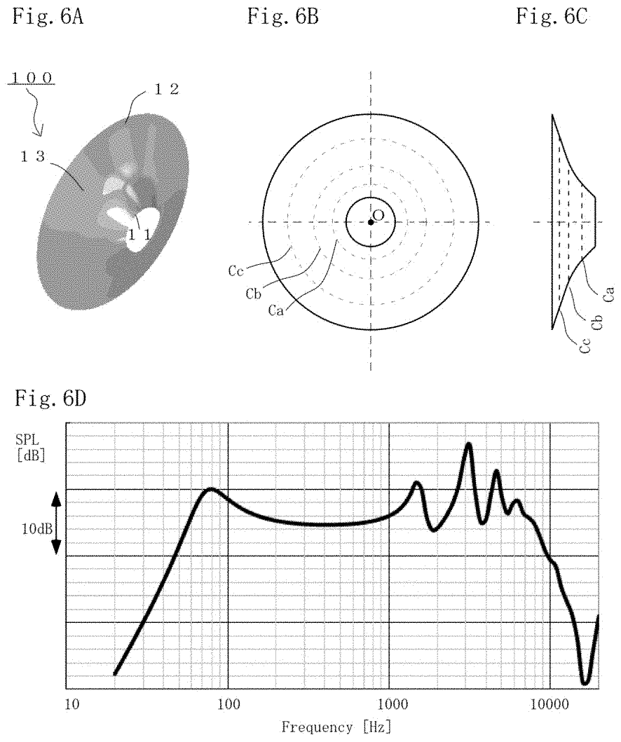

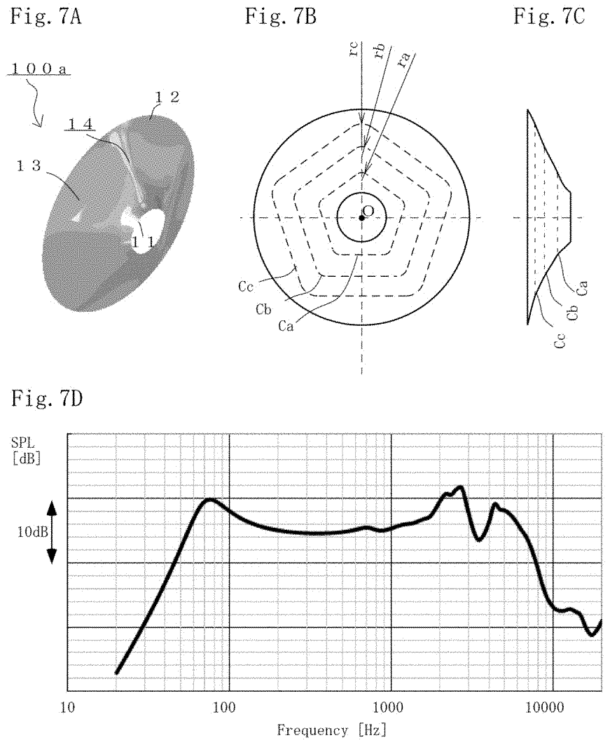

FIGS. 3A to 7D are views of the shapes of diaphragms of present embodiments and comparative examples and graphs of sound pressure frequency characteristics of electrodynamic speaker units 1 using these diaphragms. Specifically, FIGS. 3A to 5D illustrate the case of diaphragms 10, 10a, 10b of the present embodiments, and FIGS. 6A to 7D illustrate the case of diaphragms 100, 100a of comparative examples. Moreover, in each figure, A is a perspective view of the shape of the diaphragm, B is a plan view of the diaphragm, C is a side view of the diaphragm, and D is a graph of the sound pressure frequency characteristics of the electrodynamic speaker unit 1 using the diaphragm. In B and C of each figure, multiple contours Ca, Cb, Cc defining the shape of a curved surface of a diaphragm portion 13 are illustrated by dashed lines. Note that the contours defining the shape of the curved surface of the diaphragm portion 13 are defined by planes perpendicular to the Z-axis direction in which the speaker vibration system vibrates.

Note that in the diaphragm of the present embodiment or the comparative example, the diaphragm portion 13 having the substantially conical curved surface is configured such that the shape of the curved surface thereof is defined by the multiple contours Ca, Cb, Cc. At the diaphragm portion 13 of the diaphragm 10, 10a, 10b of the present embodiment, the (not-shown) contour is in a circular shape at a point closer to an inner diameter portion 11 than the contour Ca is or a point closer to an outer diameter portion 12 than the contour Cc is. Spiral recessed-raised portions 14 are formed at the diaphragm portion 13, and do not influence the shape of the inner diameter portion 11 coupled to a voice coil 4 or the shape of the outer diameter portion 12 coupled to an edge 9.

As illustrated in FIGS. 3A to 3C, in the diaphragm 10 of the present embodiment, the contour Ca closest to the inner diameter portion 11 is a regular pentagon configured such that all corner portions thereof are chamfered in an arc having the same radius ra. Moreover, the intermediate contour Cb is a substantially-similar regular pentagon rotated from the regular pentagon of the contour Ca in the circumferential direction by an angle of 15° and arranged such that the position of the corner portion of the regular pentagon in the circumferential direction is different between adjacent ones of the contours, and is also a regular pentagon configured such that all corner portions thereof are chamfered in an arc having the same radius rb (>ra). Further, the contour Cc closest to the outer diameter portion 12 is a substantially-similar regular pentagon further rotated from the regular pentagon of the contour Cb in the circumferential direction by an angle of 12° and arranged such that the position of the corner portion of the regular pentagon in the circumferential direction is different between adjacent ones of the contours, and is also a regular pentagon configured such that all corner portions thereof are chamfered in an arc having the same radius rc (>rb).

Thus, at the diaphragm 10, five spiral recessed-raised portions 14 formed by connection of the arcs of the corner portions of the contours Ca, Cb, Cc are formed at the curved surface of the diaphragm portion 13. As illustrated in the perspective view of FIG. 3A and the side view of FIG. 3C, the recessed-raised portions 14 are formed not only on a recessed side but also a raised side of a conical shape at the conical curved surface of the diaphragm portion 13 of the diaphragm 10, and therefore, stiffness of the diaphragm portion 13 is enhanced.

As a result, as illustrated in FIG. 3D, the graph of the sound pressure frequency characteristics of the electrodynamic speaker unit 1 using the diaphragm 10 shows relatively-flat frequency characteristics with less peak dip in a frequency range of about 1 kHz to about 7 kHz. This is because the spiral recessed-raised portions 14 enhance the stiffness of the diaphragm portion 13 of the diaphragm 10, and a divided vibration mode at a particular frequency is less caused.

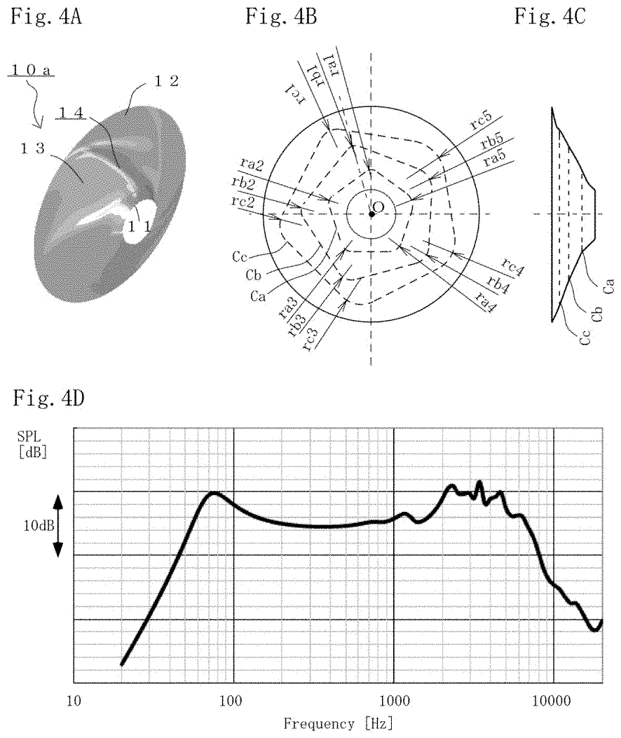

Next, as illustrated in FIGS. 4A to 4C, in the diaphragm 10a of another embodiment, the contour Ca closest to the inner diameter portion 11 is a regular pentagon configured such that all corner portions thereof are chamfered in arcs having different radiuses ra1 to ra5. Moreover, the intermediate contour Cb is a substantially-similar regular pentagon rotated from the regular pentagon of the contour Ca in the circumferential direction by an angle of 15° and arranged such that the position of the corner portion of the regular pentagon in the circumferential direction is different between adjacent ones of the contours, and is also a regular pentagon configured such that all corner portions thereof are chamfered in arcs having different radiuses rb1 to rb5 (each greater than a corresponding arc ra). Further, the contour Cc closest to the outer diameter portion 12 is a substantially-similar regular pentagon further rotated from the regular pentagon of the contour Cb in the circumferential direction by an angle of 12° and arranged such that the position of the corner portion of the regular pentagon in the circumferential direction is different between adjacent ones of the contours, and is also a regular pentagon configured such that all corner portions thereof are chamfered in arcs having different radiuses rc1 to rc5 (each greater than a corresponding arc rb).

In the diaphragm 10a, the radiuses ra1 to ra5 of the arcs in which all corner portions of the regular pentagon of the contour Ca are chamfered are set to monotonically increase in a path of a single lap around the contour Ca. That is, a radius value satisfies a relationship ra1 <ra2<ra3<ra4<ra5.

Moreover, a monotonic increase is suppressed such that a relationship of ra5≤4*ra1 is satisfied, and the maximum value ra5 of the radius of the arc of one contour is set equal to or greater than one time as great as the minimum value ra1 of the radius of another arc and equal to or less than four times as great as the minimum value ra1 of the radius of the another arc. Further, for the contour Cb, the radiuses rb1 to rb5 of the arcs satisfy, as in the contour Ca, a relationship of rb1 <rb2<rb3<rb4<rb5, and are set such that a relationship of rb5 ≤4*rb1 is satisfied. Further, for the contour Cc, the radiuses rc1 to rc5 of the arcs satisfy, as in the contour Ca, Cb, a relationship of rc1 <rc2<rc3<rc4<rc5, and are set such that a relationship of rc5≤4*rc1 is satisfied.

Thus, at the diaphragm 10a, five spiral recessed-raised portions 14 formed by connection of the arcs of the corner portions of the contours Ca, Cb, Cc are formed at the curved surface of the diaphragm portion 13 as in the case of the diaphragm 10. The maximum value of the radius of the arc at one contour is set equal to or greater than one time as great as the minimum value of the radius of another arc and equal to or less than four times as great as the minimum value of the radius of the another arc, and preferably about two times. As illustrated in the perspective view of FIG. 4A and the side view of FIG. 4C, the recessed-raised portions 14 are formed not only on a recessed side but also a raised side of a conical shape at the conical curved surface of the diaphragm portion 13 of the diaphragm 10a, and therefore, stiffness of the diaphragm portion 13 is enhanced.

As a result, as illustrated in FIG. 4D, the graph of the sound pressure frequency characteristics of the electrodynamic speaker unit 1 using the diaphragm 10a shows relatively-flat frequency characteristics with much less peak dip in a frequency range of about 1 kHz to about 7 kHz. This is because the spiral recessed-raised portions 14 enhance the stiffness of the diaphragm portion 13 of the diaphragm 10a, and a divided vibration mode at a particular frequency is less caused.

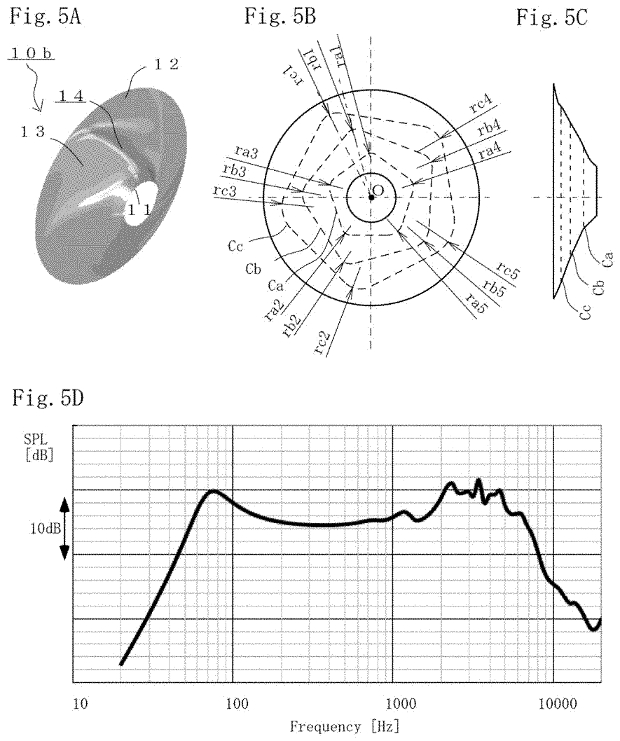

Next, as illustrated in FIGS. 5A to 5C, in the diaphragm 10b of another embodiment, the radiuses of arcs in which all corner portions of a regular pentagon of each of the contours Ca to Cc are chamfered are different from each other as in the diaphragm 10a, but the recessed-raised portions 14 are formed in a changed order such that the radius does not monotonically increase or decrease in a path of a single lap around the contour. For example, as illustrated in FIG. 5B, the arcs of the chamfered corner portions of the regular pentagon are formed such that a radius value is in the order of ra1, ra3, ra2, ra5, and ra4 in a path of a single lap around the contour Ca, and therefore, these radiuses are set not to monotonically increase or decrease. Similarly, in a path of a single lap around the contour Cb, a radius value is set in the order of rb1, rb3, rb2, rb5, and rb4. Similarly, in a path of a single lap around the contour Cc, a radius value is set in the order of rc1, rc3, rc2, rc5, and rc4, and these values are set not to monotonically increase or decrease.

Thus, at the diaphragm 10b, five spiral recessed-raised portions 14 formed by connection of the arcs of the corner portions of the contours Ca, Cb, Cc are formed at the curved surface of the diaphragm portion 13 as in the case of the diaphragm 10, 10a. As illustrated in the perspective view of FIG. 5A and the side view of FIG. 5C, the recessed-raised portions 14 are formed not only on a recessed side but also a raised side of a conical shape at the conical curved surface of the diaphragm portion 13 of the diaphragm 10b, and therefore, stiffness of the diaphragm portion 13 is enhanced. Note that in the case of the diaphragm 10b, a difference (e.g., ra4 and ra1) in magnitude between the arc of the first corner portion and the arc of the last corner portion in the path of the single lap around the contour is smaller than that in the case of the diaphragm 10a with the monotonically-increasing radiuses (e.g., ra5 and ra1), and therefore, there is an advantage that visual quality of an outer appearance of the curved surface of the diaphragm portion 13 can be improved.

As a result, as illustrated in FIG. 5D, the graph of the sound pressure frequency characteristics of the electrodynamic speaker unit 1 using the diaphragm 10b shows relatively-flat frequency characteristics with much less peak dip in a frequency range of about 1 kHz to about 7 kHz. This is because the spiral recessed-raised portions 14 enhance the stiffness of the diaphragm portion 13 of the diaphragm 10b, and a divided vibration mode at a particular frequency is less caused.

Next, as illustrated in FIGS. 6A to 6C, in the diaphragm 100 of the comparative example, no spiral recessed-raised portions 14 are, unlike the diaphragms 10, 10a, 10b of the above-described present embodiments, formed at the curved surface of the diaphragm portion 13. Each of the contour Ca closest to an inner diameter portion 11, the intermediate contour Cb, and the contour Cc closest to an outer diameter portion 12 is a circular contour as illustrated in FIG. 6B. Thus, the diaphragm 100 of the comparative example is a comparative example showing an effect of the spiral recessed-raised portions 14 enhancing the stiffness of the diaphragm portion 13.

As illustrated in FIG. 6D, the graph of the sound pressure frequency characteristics of the electrodynamic speaker unit 1 using the diaphragm 100 of the comparative example shows a great peak dip in a frequency range of about 1 kHz to about 7 kHz, and shows non-flat frequency characteristics. This is because the stiffness of the diaphragm portion 13 of the diaphragm 100 is lowered due to the absence of the spiral recessed-raised portions 14, and a divided vibration mode at a particular frequency is easily caused.

Next, the diaphragm 100a of the comparative example is partially different from the diaphragms 10, 10a, 10b of the above-described present embodiments as illustrated in FIGS. 7A to 7C. Recessed-raised portions 14 are formed at the curved surface of the diaphragm portion 13. However, the recessed-raised portions 14 are not in a spiral shape but in a linear shape in a radial direction. The contour Ca is a regular pentagon configured such that all corner portions thereof are chamfered in an arc having the same radius ra. Moreover, the contours Cb, Cc are substantially-similar regular pentagons not rotated from the regular pentagon of the contour Ca in the circumferential direction and arranged such that the position of the corner portion of the regular pentagon in the circumferential direction are the same between adjacent ones of the contours, and are also regular pentagons configured such that all corner portions thereof are chamfered in an arc having the same radius rb (>ra) or the same radius rc (>rb). Thus, the diaphragm 100a of the comparative example is a comparative example showing an effect of the spiral shape of the spiral recessed-raised portions 14 enhancing the stiffness of the diaphragm portion 13 of the diaphragm 10 of the present embodiment.

As illustrated in FIG. 7D, the graph of the sound pressure frequency characteristics of the electrodynamic speaker unit 1 using the diaphragm 100a of the comparative example shows a great peak dip at around about 2.5 kHz in a frequency range of about 1 kHz to about 7 kHz, and shows non-flat frequency characteristics. This is because stiffness of the diaphragm portion 13 of the diaphragm 100a is lowered due to the non-spiral shape of the recessed-raised portions 14, and a divided vibration mode at a particular frequency is easily caused.

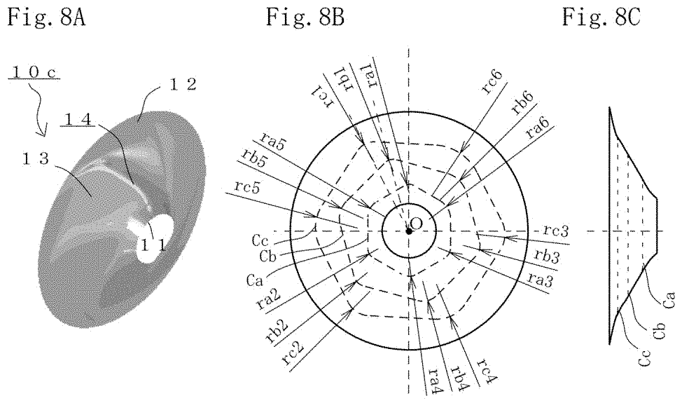

FIGS. 8A to 8C are views of the shape of a diaphragm 10c of another embodiment. Specifically, FIG. 8A is a perspective view of the shape of the diaphragm 10c, FIG. 8B is a plan view of the diaphragm 10c, and FIG. 8C is a side view of the diaphragm 10c.

As illustrated in FIGS. 8A to 8C, in the diaphragm 10c of the present embodiment, a contour Ca closest to an inner diameter portion 11 is a regular hexagon configured such that all corner portions thereof are chamfered in arcs having different radiuses ra1 to ra6. Moreover, an intermediate contour Cb is a substantially-similar regular hexagon rotated from the regular hexagon of the contour Ca in the circumferential direction by an angle of 15° and arranged such that the position of the corner portion of the regular hexagon in the circumferential direction is different between adjacent ones of the contours, and is also a regular hexagon configured such that all corner portions thereof are chamfered in arcs having different radiuses rb1 to rb6 (each greater than a corresponding arc ra). Further, a contour Cc closest to an outer diameter portion 12 is a substantially-similar regular hexagon further rotated from the regular hexagon of the contour Cb in the circumferential direction by an angle of 12° and arranged such that the position of the corner portion of the regular hexagon in the circumferential direction is different between adjacent ones of the contours, and is also a regular hexagon configured such that all corner portions thereof are chamfered in arcs having different radiuses rc1 to rc6 (each greater than a corresponding arc rb).

At the diaphragm 10c, recessed-raised portions 14 are formed in a changed order such that the radiuses ra1 to ra6 of the arcs in which all corner portions of the regular hexagon of the contour Ca are chamfered do not monotonically increase or decrease in a path of a single lap around the contour. For example, as illustrated in FIG. 8B, the arcs in which the corner portions of the regular hexagon are chamfered are formed in the order of the radiuses ra1, ra5, ra2, ra4, ra3, and ra6 in a path of a single lap around the contour Ca, and these radiuses are set not to monotonically increase or decrease. Similarly, in a path of a single lap around the contour Cb, the arcs are formed in the order of the radiuses rb1, rb5, rb2, rb4, rb3, and rb6. Similarly, in a path of a single lap around the contour Cc, the arcs are formed in the order of the radiuses rc1, rc5, rc2, rc4, rc3, and rc6, and these radiuses are set not to monotonically increase or decrease.

Thus, at the diaphragm 10c, six spiral recessed-raised portions 14 formed by connection of the arcs of the corner portions of the contours Ca, Cb, Cc are formed at a curved surface of a diaphragm portion 13. As illustrated in the perspective view of FIG. 8A and the side view of FIG. 8C, the recessed-raised portions 14 are formed not only on a recessed side but also on a raised side of a conical shape at the conical curved surface of the diaphragm portion 13 of the diaphragm 10a, and enhance stiffness of the diaphragm portion 13. As a result, sound pressure frequency characteristics of an electrodynamic speaker unit 1 using the diaphragm 10c show relatively-flat frequency characteristics with less peak dip in a frequency range of about 1 kHz to about 7 kHz. This is because six spiral recessed-raised portions 14 enhance the stiffness of the diaphragm portion 13 of the diaphragm 10c and a divided vibration mode at a particular frequency is less caused.

Note that as in the diaphragm 10c, the multiple contours Ca, Cb, Cc defining the shape of the curved surface of the diaphragm portion 13 configured to emit a sound wave may be defined by multiple regular polygons configured such that all corner portions thereof are chamfered in arcs. The regular polygon is preferably one with a smaller number of corner portions to some extent, such as a regular triangle, a square, a regular pentagon, a regular hexagon, a regular heptagon, or a regular octagon. For example, when the number of corner portions of the regular polygon is 10 or more, the regular polygon becomes closer to a circle, and therefore, there is a probability that the effect of enhancing the stiffness of the diaphragm portion 13 is less exhibited even when the spiral recessed-raised portions 14 are formed. Moreover, the regular polygon may be the regular triangle. In a case where it is set such that all radiuses r of arcs in which corner portions of the regular triangle are chamfered are set to be different from each other, it is inevitable that the monotonically-increasing or -decreasing different radiuses are set in a path of a single lap around one contour. Needless to say, the contours arranged as the regular polygons are not limited to three contours such as the above-described contours Ca, Cb, Cc. As long as multiple contours are provided, a greater number of contours may be finely set.

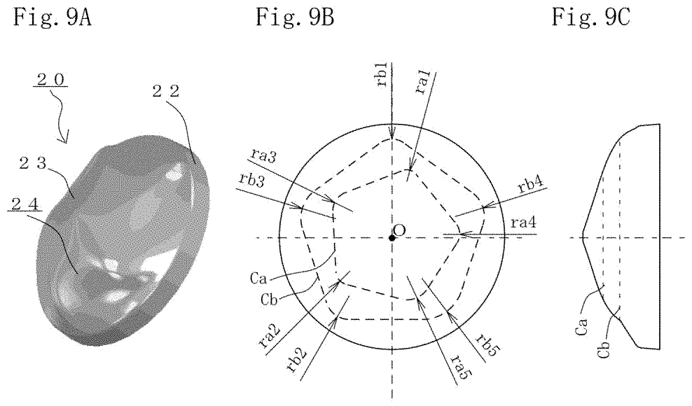

FIGS. 9A to 9C are views of the shape of a dust cap 20 of another embodiment. Specifically, FIG. 9A is a perspective view of the shape of the dust cap 20, FIG. 9B is a plan view of the dust cap 20, and FIG. 9C is a side view of the dust cap 20. The dust cap 20 has an outer diameter portion 22 defining a circular edge portion, and a substantially-dome-shaped diaphragm portion 23. Multiple spiral recessed-raised portions 24 are formed at a curved surface of the diaphragm portion 23.

As illustrated in FIGS. 9A to 9C, in the dust cap 20 of the present embodiment, a contour Ca closest to a center point O is a regular pentagon configured such that all corner portions thereof are chamfered in arcs having different radiuses ra1 to ra5. Moreover, a contour Cb closest to the outer diameter portion 22 is a substantially-similar regular pentagon rotated from the regular pentagon of the contour Ca in the circumferential direction by an angle of 12° and arranged such that the position of the corner portion of the regular pentagon in the circumferential direction is different between adjacent ones of the contours, and is a regular pentagon configured such that all corner portions thereof are chamfered in arcs having different radiuses rb1 to rb5 (each greater than a corresponding arc ra).

At the dust cap 20, recessed-raised portions 14 are formed in a changed order such that the radiuses ra1 to ra5 of the arcs in which all corner portions of the regular pentagon of the contour Ca are chamfered do not monotonically increase or decrease in a path of a single lap around the contour. For example, as illustrated in FIG. 9B, the arcs in which the corner portions of the regular pentagon are chamfered are formed in the order of the radiuses ra1, ra3, ra2, ra5, and ra4 in a path of a single lap around the contour Ca, and these radiuses are set not to monotonically increase or decrease. Similarly, in a path of a single lap around the contour Cb, the arcs are formed in the order of the radiuses rb1, rb3, rb2, rb5, and rb4, and these radiuses are set not to monotonically increase or decrease.

Thus, at the dust cap 20, five spiral recessed-raised portions 24 formed by connection of the arcs of the corner portions of the contours Ca, Cb are formed at the curved surface of the diaphragm portion 23. As illustrated in the perspective view of FIG. 9A and the side view of FIG. 9C, the recessed-raised portions 24 are formed not only on a raised side but also on a recessed side at the dome-shaped curved surface of the diaphragm portion 23 of the dust cap 20, and enhance stiffness of the diaphragm portion 23. As a result, sound pressure frequency characteristics of an electrodynamic speaker unit 1 using the dust cap 20 show relatively-flat frequency characteristics with less peak dip in a high frequency range of equal to or higher than about 1 kHz. This is because five spiral recessed-raised portions 24 enhance the stiffness of the diaphragm portion 23 of the dust cap 20, and a divided vibration mode at a particular frequency is less caused.

FIGS. 9A to 9C illustrate the case of the dust cap 20 of another embodiment, but the diaphragm of the present invention may be a dome-shaped diaphragm configured to emit a sound wave as in the dust cap 20. Regardless of a diaphragm nominal diameter and a diaphragm shape, the diaphragm of the present invention may be a balance dome-shaped diaphragm formed by combination of a dome-shaped diaphragm and a conical diaphragm. Needless to say, the diaphragm may be a conical diaphragm configured such that a dust cap portion is integrally formed. Moreover, the dust cap may be one including a sub-cone as a diaphragm.

Note that a material forming the diaphragm 10 or the dust cap 20 of the present embodiment may be a resin material. For example, the resin material forming the diaphragm 10 or the dust cap 20 may be a PET film-shaped member. The material forming the diaphragm 10 or the dust cap 20 may be, for example, other lightweight resin material films such as polyetheretherketone (PEEK), polyetherimide (PEI), polyethylenenaphthalate (PEN), polycarbonate (PC), polyimide (PI), polyarylate (PAR), and polyphenylene sulfide (PPS), materials formed by hot pressing of sheets, and materials formed by pressing of elastomer sheets. Alternatively, the material forming the diaphragm 10 or the dust cap 20 may be non-woven fabric made of natural fibers such as cellulose or synthetic fibers, or paper materials.

The diaphragm of the present invention is not limited to the illustrated electrodynamic speaker unit, and may be a speaker unit forming a speaker vibration system without a damper. Moreover, the diaphragm of the present invention is not limited to the electrodynamic speaker unit, and is also applicable to a piezoelectric speaker unit.

What is claimed is:

1. A diaphragm or a dust cap forming an electrodynamic speaker unit, wherein multiple contours defining a shape of a curved surface of a diaphragm portion configured to emit a sound wave are each defined by multiple regular polygons configured such that all corner portions thereof are chamfered in arcs, the regular polygons are arranged with different predetermined rotation angles about a center point of a concentric circle such that a position of each corner portion of each regular polygon in a circumferential direction is different between adjacent ones of the contours, and spiral recessed-raised portions corresponding to the multiple contours are formed at the curved surface.

2. The diaphragm or the dust cap according to claim 1, wherein radiuses r of the arcs in which the corner portions of each regular polygon are chamfered are set to be different among all corner portions of one of the contours.

3. The diaphragm or the dust cap according to claim 2, wherein a maximum value rₘₐₓ of the radius r of one of the arcs at one of the contours is set equal to or greater than one time as great as a minimum value rₘᵢₙ of the radius r of another one of the arcs and equal to or less than four times as great as the minimum value rₘᵢₙ of the radius r of the another one of the arcs.

4. The diaphragm or the dust cap according to claim 2, wherein each regular polygon is a regular triangle, a square, a regular pentagon, a regular hexagon, a regular heptagon, or a regular octagon.

5. The diaphragm or the dust cap according to claim 4, wherein in a case where each regular polygon is the square, the regular pentagon, the regular hexagon, the regular heptagon, or the regular octagon, the radiuses r of the arcs in which the corner portions of each regular polygon are chamfered are differently set without monotonically increasing or decreasing in a path of a single lap around one of the contours.

6. The diaphragm according to claim 2, further comprising:
an inner diameter portion defining a circular hole;
an outer diameter portion defining a circular edge portion as a circle concentric with the inner diameter portion; and
the diaphragm portion having the substantially conical curved surface connecting the inner diameter portion and the outer diameter portion, wherein
the radiuses r of the arcs in which the corner portions of each regular polygon are chamfered are set greater in the case of the contour closer to the outer diameter portion than in the case of the contour closer to the inner diameter portion.

7. A speaker unit comprising at least:
the diaphragm according to claim 1;
a voice coil coupled to the inner diameter portion of the diaphragm;
an edge coupled to the outer diameter portion of the diaphragm;
a frame fixed to an outer peripheral end portion of the edge; and
a magnetic circuit having a magnetic gap in which a coil of the voice coil is arranged and fixed to the frame.

8. A speaker unit comprising at least:
a conical diaphragm;
a voice coil coupled to an inner diameter portion of the diaphragm;
the dust cap according to claim 1, the dust cap being coupled to the diaphragm or the voice coil;
an edge coupled to an outer diameter portion of the diaphragm;
a frame fixed to an outer peripheral end portion of the edge; and
a magnetic circuit having a magnetic gap in which a coil of the voice coil is arranged and fixed to the frame.
